(19) United States
(12) Patent Application Publication
(10) Pub. No.: US 2019/0337359 A1
(43) Pub. Date: Nov. 7, 2019

(54) REFRIGERATION CYCLE DEVICE

(71) Applicant: DENSO CORPORATION, Kariya-city (JP)

(72) Inventor: Tatsuya TOYAMA, Kariya-city (JP)

(21) Appl. No.: 16/509,604

(22) Filed: Jul. 12, 2019

Related U.S. Application Data
(63) Continuation of application No. PCT/JP2017/046330, filed on Dec. 25, 2017.

(30) Foreign Application Priority Data
Feb. 23, 2017 (JP) 2017-032471

(51) Int. Cl. B60H 1/32

(52) U.S. Cl. CPC B60H 1/3227

(57) ABSTRACT

In a refrigeration cycle device, a variable throttle mechanism is provided in a refrigerant passage that connects an evaporator and a compressor, and is configured to be capable of changing a passage cross-sectional area of the refrigerant passage. A radiator includes a plurality of tubes and a header tank. The plurality of tubes, through which the refrigerant discharged from the compressor flows, are stacked in a stacking direction. The header tank is provided at an end side in a longitudinal direction of each of the plurality of tubes and communicates with the plurality of tubes. A tank interior space of the header tank is partitioned into a plurality of sections that are arranged in the stacking direction. The header tank includes an opening/closing mechanism configured to open or close a communication portion that causes adjacent ones of the plurality of sections to communicate with each other.

### CROSS REFERENCE TO RELATED APPLICATIONS

The present application is a continuation application of International Patent Application No. PCT/JP2017/046330 filed on Dec. 25, 2017, which designated the United States and claims the benefit of priority from Japanese Patent Application No. 2017-032471 filed on Feb. 23, 2017. The entire disclosures of all of the above applications are incorporated herein by reference.

### TECHNICAL FIELD

The present disclosure relates to a refrigeration cycle device used for air conditioners.

### BACKGROUND

A subcool condenser is known as a radiator of a refrigeration cycle device. The subcool condenser includes a condensing portion that condenses a refrigerant, a receiver that separates the refrigerant cooled by the condensing portion into a liquid-phase refrigerant and a gas-phase refrigerant, and a subcooling portion that subcools the liquid-phase refrigerant separated in the receiver.

### SUMMARY

According to an aspect of the present disclosure, a refrigeration cycle device includes a compressor, a radiator, a decompression device, an evaporator and a variable throttle mechanism. The compressor compresses and discharges a refrigerant, and the radiator is configured to dissipate heat from the refrigerant discharged from the compressor. The decompression device is configured to decompress the refrigerant flowing out of the radiator, and the evaporator is configured to evaporate the refrigerant decompressed by the decompression device. The variable throttle mechanism is provided in a refrigerant passage that connects the evaporator and the compressor, and is configured to be capable of changing a passage cross-sectional area of the refrigerant passage. The radiator includes a plurality of tubes through which the refrigerant discharged from the compressor circulates, and the plurality of tubes are stacked in a stacking direction. A header tank is provided at an end side in a longitudinal direction of the plurality of tubes to communicate with the plurality of tubes. A tank interior space of the header tank is partitioned into a plurality of sections arranged in the stacking direction, and the header tank includes an opening/closing mechanism configured to open or close a communication portion through which adjacent sections of the plurality of sections communicate with each other.

### BRIEF DESCRIPTION OF THE DRAWINGS

The above-mentioned object, other objects, features, and advantages of the present disclosure will become more apparent by the following detailed description in conjunction with the accompanying drawings.

FIG. 1 is an entire configuration diagram showing a refrigeration cycle device according to a first embodiment;

FIG. 2 is a front view showing a radiator of the first embodiment;

FIG. 3 is an explanatory diagram showing the flow of a refrigerant during a normal operation in the radiator of the first embodiment;

FIG. 4 is an enlarged cross-sectional view showing an iris diaphragm mechanism of the first embodiment;

FIG. 5 is a flowchart showing control processing executed by a controller of a vehicle air conditioner in the first embodiment;

FIG. 6 is an entire configuration diagram showing the flow of a refrigerant when a high pressure in the refrigeration cycle of the first embodiment is lowered; and

FIG. 7 is an entire configuration diagram showing a refrigeration cycle device according to a second embodiment.

### DESCRIPTION OF EMBODIMENTS

A refrigeration cycle device including a subcool condenser may be designed to have the largest possible area of a heat exchange core of the radiator in order to ensure the maximum air-cooling capacity when an outside air temperature is high, such as in summer.

On the other hand, when the air-cooling capacity is not required so much, like in winter, that is, at the time of a low load on an air conditioner, the rotational speed of a compressor is decreased so as to reduce or save the capacity of the air conditioner while keeping the degree of superheat in an evaporator constant. However, in such a case, the suction pressure of the compressor may rise, thus making it difficult to ensure a pressure difference and pressure ratio required for the compressor. If the rotational speed of the compressor is not decreased, the air conditioning capacity becomes excessive, and thus the compressor needs to be operated intermittently. Consequently, the air conditioner has difficulty in ensuring a dehumidifying capacity necessary for the anti-fogging property and would deteriorate its energy saving property.

A refrigeration cycle device may be designed to adjust its refrigeration capacity by providing a suction-pressure regulating valve in a low-pressure pipe connecting an outlet side of the evaporator and a suction side of the compressor.

In this case, the refrigeration cycle device can adjust the refrigeration capacity of the refrigeration cycle, but cannot avoid intermittent operation of the compressor at the time of a low load on the air conditioner.

The present disclosure to provide a refrigeration cycle device which can suppress an intermittent operation of a compressor.

According to an example of the present disclosure, a refrigeration cycle device includes a compressor that compresses and discharges a refrigerant; a radiator as a subcool condenser configured to dissipate heat from the refrigerant discharged from the compressor; a decompression device configured to decompress the refrigerant flowing out of the radiator; an evaporator configured to evaporate the refrigerant decompressed by the decompression device; and a variable throttle mechanism provided in a refrigerant passage that connects the evaporator and the compressor. The variable throttle mechanism is configured to be capable of changing a passage cross-sectional area of the refrigerant passage. The radiator includes a plurality of tubes through which the refrigerant discharged from the compressor flows, and a header tank provided on an end side in a longitudinal direction of the plurality of tubes and communicating with the plurality of tubes. A tank interior space of the header tank is partitioned into a plurality of sections arranged in the stacking direction, and the header tank includes an opening/closing mechanism configured to open or close a communication portion through which adjacent sections of the plurality of sections communicate with each other. The opening/closing mechanism may be an iris diaphragm mechanism.

With such a configuration, the passage cross-sectional area of the refrigerant passage is reduced by the variable throttle mechanism in a low load condition, such as in winter. Consequently, the specific volume of the suction refrigerant in the compressor rises, so that the flow rate of the refrigerant discharged from the compressor can be reduced. Thus, the intermittent operation of the compressor that would otherwise occur under the low load condition can be effectively suppressed.

In the low load condition, such as in winter, the communication portion in the radiator is opened by the opening/closing mechanism, thus making it possible to reduce a heat exchange region (heat exchange area) for exchanging heat between the refrigerant and the heat medium in the radiator. Thus, the high-pressure side pressure in the refrigeration cycle rises, so that the flow rate of the refrigerant circulating in the refrigeration cycle is increased. Therefore, even in the low load condition, the refrigerant flow in the refrigeration cycle can be stabilized to thereby suppress the intermittent operation of the refrigeration cycle.

Hereinafter, detail embodiments of the present disclosure will be described with reference to the accompanying drawings. In the respective embodiments below, the same or equivalent parts are indicated by the same reference characters throughout the figures.

### First Embodiment

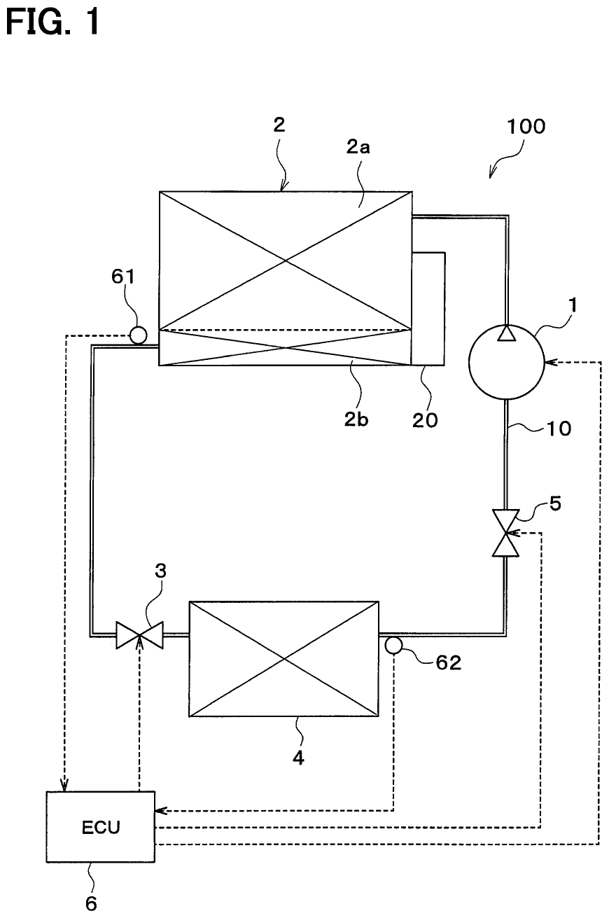

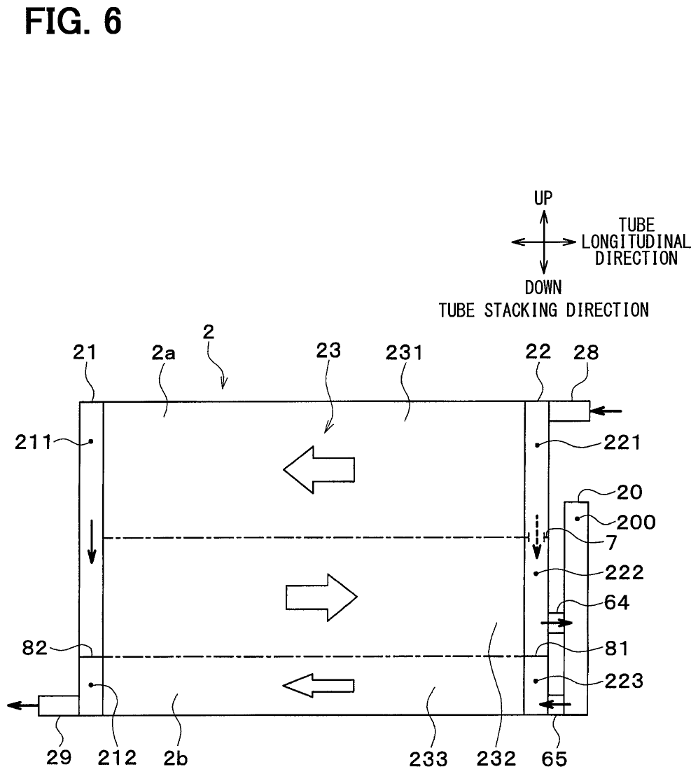

A first embodiment will be described based on FIGS. 1 to 6. A refrigeration cycle device 100 shown in FIG. 1 is used in a vehicle air conditioner. The vehicle air conditioner is an air conditioner that adjusts the interior space of a vehicle cabin to an appropriate temperature.

Specifically, the refrigeration cycle device 100 is a vapor compression refrigeration cycle that is configured by annularly connecting a compressor 1, a radiator 2, an expansion valve 3, an evaporator 4, and the like. The refrigeration cycle device 100 of the present embodiment configures a subcritical refrigeration cycle in which a high-pressure side refrigerant pressure does not exceed the critical pressure of the refrigerant, using a hydrofluorocarbon (HFC)-based refrigerant (e.g., R134a) as the refrigerant. Obviously, a hydrofluoroolefin (HFO)-based refrigerant (e.g., R1234yf) or the like may be adopted as the refrigerant. Furthermore, refrigerating machine oil for lubricating the compressor 1 is mixed into the refrigerant, and part of the refrigerating machine oil circulates in the cycle, together with the refrigerant.

The compressor 1 draws, compresses, and discharges the refrigerant in the refrigeration cycle device 100. The compressor 1 is configured as an electric compressor that includes a fixed displacement compression mechanism having a discharge capacity fixed and driven by an electric motor. The compression mechanism can employ various types of compression mechanisms, such as a scroll compression mechanism and a vane compression mechanism. The electric motor included in the compressor 1 has its operation (rotational speed) controlled by a control signal output from an air-conditioning controller 6 to be described later. The electric motor may adopt either an AC motor or a DC motor. The air-conditioning controller 6 controls the rotational speed of the electric motor, thereby changing the refrigerant discharge capacity of the compression mechanism.

The radiator 2 is a heat exchanger that exchanges heat between a high-pressure refrigerant discharged from the compressor 1 and the outside air to thereby dissipate the heat from the high-pressure refrigerant. The detailed structure of the radiator 2 will be described later.

The expansion valve 3 is a decompression device that decompresses a high-pressure refrigerant flowing out of the radiator 2. The expansion valve 3 is an electric variable throttle that includes a valve body capable of changing its throttle opening degree and an electric actuator for changing the opening degree of the valve body. The expansion valve 3 has its operation controlled by a control signal output from the air-conditioning controller 6.

The evaporator 4 is a heat exchanger that exchanges heat between a low-pressure refrigerant decompressed and expanded by the expansion valve 3 and the ventilation air in the interior of the vehicle cabin, thereby evaporating the low-pressure refrigerant to exhibit a heat absorption effect of the low-pressure refrigerant, thus cooling the ventilation air. The evaporator 4 of the present embodiment is a so-called tank-and-tube type heat exchanger that includes one tank for collecting or distributing the refrigerant, a plurality of tubes through which the refrigerant circulates, and the other tank connected to the plurality of tubes for collecting or distributing the refrigerant.

The refrigeration cycle device 100 includes a variable throttle mechanism 5 that is provided in a refrigerant passage 10 connecting the evaporator 4 and the compressor 1. The variable throttle mechanism 5 is configured to be capable of changing the passage cross-sectional area of the refrigerant passage 10. That is, the variable throttle mechanism 5 is provided between the outlet side of the evaporator 4 and the intake side of the compressor 1.

The variable throttle mechanism 5 includes a valve body capable of changing its throttle opening degree and an electric actuator for changing the throttle opening degree of the valve body. The variable throttle mechanism 5 has its operation controlled by a control signal output from the air-conditioning controller 6.

The air-conditioning controller 6 is configured of a known microcomputer, including a CPU, ROM, and RAM, and a peripheral circuit thereof. The air-conditioning controller 6 controls the operations of various air-conditioning control target devices that are connected to its output side by performing various computations and processing based on air-conditioning control programs stored in the ROM.

The output side of the air-conditioning controller 6 is connected to the compressor 1, the expansion valve 3, the variable throttle mechanism 5, other electric actuators, and the like.

The input side of the air-conditioning controller 6 is connected to a high-pressure side pressure sensor 61, a low-pressure side pressure sensor 62, and the like. Detection signals from a group of these sensors for air-conditioning control are input to the air-conditioning controller 6.

The high-pressure side pressure sensor 61 is a high-pressure refrigerant pressure detector that detects the high-pressure side refrigerant pressure in a refrigerant passage leading from the discharge port side of the compressor 1 to the inlet side of the expansion valve 3. In the present embodiment, the high-pressure side pressure sensor 61 detects a refrigerant pressure on the outlet side of the radiator 2, as a high-pressure side refrigerant pressure Ph.

The low-pressure side pressure sensor 62 is a low-pressure refrigerant pressure detector that detects the low-pressure side refrigerant pressure in a refrigerant passage leading from an outlet side of the expansion valve 3 to the intake side of the compressor 1. In the present embodiment, the low-pressure side pressure sensor 62 detects a refrigerant pressure on the outlet side of the evaporator 4, as a low-pressure side refrigerant pressure Pl.

Next, the detailed structure of the radiator 2 in the present embodiment will be described. The radiator 2 stores a liquid-phase refrigerant so as to retain the refrigerant in the refrigeration cycle.

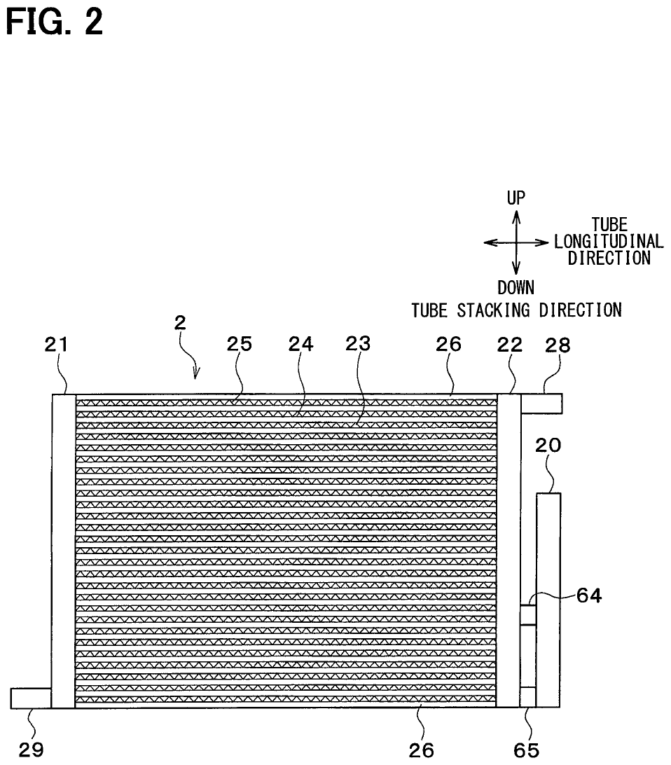

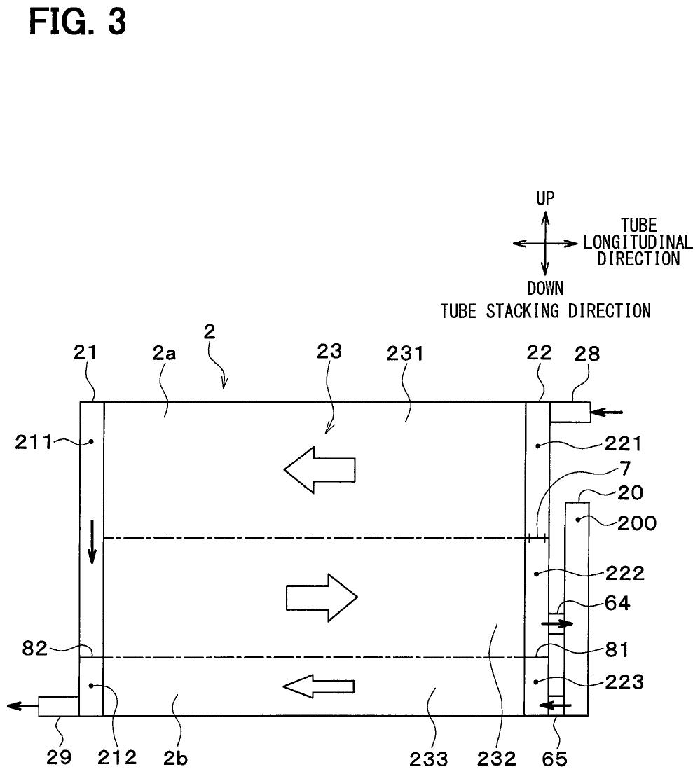

As shown in FIGS. 2 and 3, the radiator 2 is a refrigerant sub-cool condenser integrated with a modulator tank. That is, the radiator 2 includes a condensing portion 2a, a subcooling portion 2b, and a modulator tank 20 and is formed by integrating these components.

The condensing portion 2a is a heat exchanging portion that exchanges heat between the refrigerant discharged from the compressor 1 and the air (outer fluid), thereby condensing the gas-phase refrigerant. The modulator tank 20 is a gas-liquid separating portion that separates the refrigerant flowing thereinto from the condensing portion 2a, into a gas-phase refrigerant and a liquid-phase refrigerant. The modulator tank 20 causes the liquid-phase refrigerant to flow therefrom, while storing therein an excess refrigerant in the form of the liquid-phase refrigerant within the refrigeration cycle. The subcooling portion 2b is a heat exchanging portion that exchanges heat between the liquid-phase refrigerant flowing thereinto from the modulator tank 20 and the air, thereby cooling the liquid-phase refrigerant to increase the degree of subcooling of the refrigerant. The modulator tank 20 of the present embodiment is formed in a cylindrical shape extending in the vertical direction (i.e., in the gravitational direction).

The radiator 2 has a first header tank 21 and a second header tank 22 that are a pair of cylindrical header tanks spaced apart from each other by a predetermined distance. A heat exchange core 23 is disposed between the first header tank 21 and the second header tank 22. The core 23 includes the condensing portion 2a and the subcooling portion 2b. The radiator 2 is a so-called multi-flow type heat exchanger in which the refrigerant flowing into the first header tank 21 is divided into a plurality of refrigerant passages to flow toward the second header tank 22.

In more detail, as shown in FIG. 2, the radiator 2 includes tubes 24, the first header tank 21, and the second header tank 22. The plurality of tubes 24, through which a refrigerant discharged from the compressor 1 circulates, are stacked one upon the other. Each of the tubes 24 is formed to have a flat cross-sectional shape and causes the refrigerant to horizontally flow between the first header tank 21 and the second header tank 22. The first header tank 21 and the second header tank 22 are provided on the respective ends in the longitudinal direction of the tubes 24 and communicate with the tubes 24.

The plurality of tubes 24 are stacked to form the above-mentioned core 23. An outer fin 25 having a wave shape (corrugated shape) is provided between the adjacent tubes 24. The tubes 24 and the outer fins 25 are joined to each other by brazing.

Hereinafter, the longitudinal direction of the tube 24 is referred to as a tube longitudinal direction, whereas the stacking direction of the tubes 24 is referred to as a tube stacking direction.

One end in the tube longitudinal direction of the tube 24 is disposed to communicate with the inside of the first header tank 21. The other end in the tube longitudinal direction of the tube 24 is disposed to communicate with the inside of the second header tank 22. Each tube 24 forming the core 23 includes a multi-hole tube that has a plurality of small passages therein. Such a multi-hole tube can be formed by extrusion.

Side plates 26 for reinforcing the core 23 are respectively provided on both ends in the tube stacking direction of the core 23. Each of the side plates 26 extends in parallel with the tube longitudinal direction and has its both ends connected to the first header tank 21 and the second header tank 22.

An inlet side pipe joint 28 for the refrigerant is provided at the upper end side of the second header tank 22. The inlet side pipe joint 28 is joined to the second header tank 22. The inlet side pipe joint 28 is a connection member that connects an interior space (first space 221 to be described later) located on an upper side of the second header tank 22 with an inlet side pipe (not shown) into which the refrigerant flows.

An outlet side pipe joint 29 for the refrigerant is provided at the lower end side of the first header tank 21. The outlet side pipe joint 29 is joined to the first header tank 21. The outlet side pipe joint 29 is a connection member that connects an interior space (fifth space 212 to be described later) located on a lower side of the first header tank 21 with an outlet side pipe (not shown) through which the refrigerant flows to the outside.

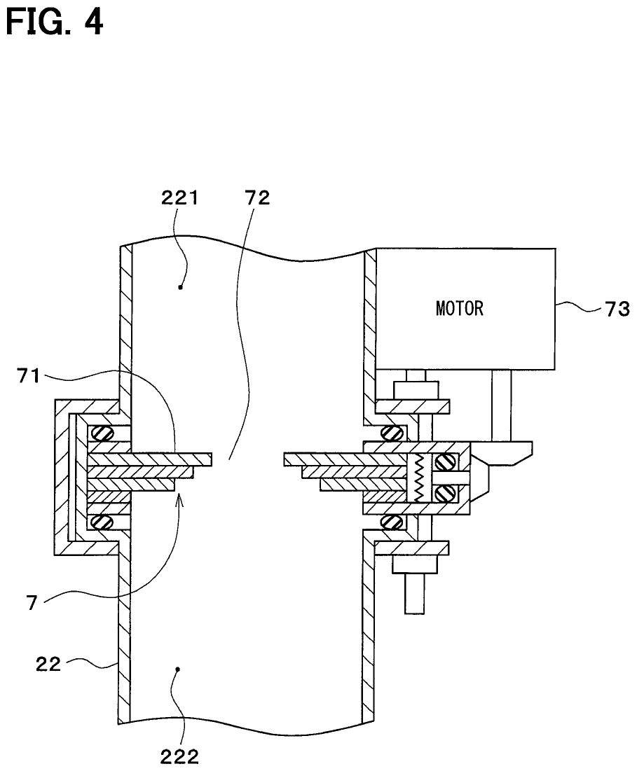

As shown in FIGS. 3 and 4, an iris diaphragm mechanism 7 is provided inside the second header tank 22. The iris diaphragm mechanism 7 is a diaphragm throttle mechanism that includes a plurality of diaphragm blades 71 arranged in a ring shape. The iris diaphragm mechanism 7 has an inner diameter thereof changed continuously.

When the inner diameter of the iris diaphragm mechanism 7 is set to zero, that is, the iris diaphragm mechanism 7 is completely closed, a tank interior space of the second header tank 22 is partitioned into two sections (spaces) arranged in the tube stacking direction, namely, a first space 221 and a second space 222.

When the inner diameter of the iris diaphragm mechanism 7 is set to more than zero, that is, the iris diaphragm mechanism 7 is opened, the adjacent first space 221 and second space 222 communicate with each other. At this time, the first space 221 and the second space 222 communicate with each other via a passage 72 that is formed by the plurality of diaphragm blades 71 of the iris diaphragm mechanism 7 and which is opened and closed by the plurality of diaphragm blades 71. Therefore, the iris diaphragm mechanism 7 configures an opening/closing mechanism that opens and closes the passage 72 as a communicating portion for communicating two adjacent sections, namely, the first space 221 and the second space 222.

The plurality of diaphragm blades 71 of the iris diaphragm mechanism 7 are driven by a servo motor 73. The operation of the servo motor 73 is controlled by a control signal output from the air-conditioning controller 6.

Returning to FIG. 3, inside the second header tank 22, one piece of separator, namely, a first separator 81 is disposed to partition the tank interior space in the tube stacking direction (vertical direction). The first separator 81 is disposed below the iris diaphragm mechanism 7.

The interior of the second header tank 22 is partitioned into three sections arranged in the tube stacking direction (vertical direction), namely, the first space 221, the second space 222, and a third space 223 by the iris diaphragm mechanism 7 and the first separator 81.

Inside the first header tank 21, a second separator 82 is disposed to partition the tank interior space in the tube stacking direction. The tank interior space of the first header tank 21 is partitioned into two sections arranged in the tube stacking direction, namely, a fourth space 211 and the fifth space 212 by the second separator 82.

The core 23 has three flow-passage groups arranged in the vertical direction. Hereinafter, in the core 23, the flow-passage group located at the highest position in the vertical direction is referred to as a first flow-passage group 231, the flow-passage group located at the second highest position from above in the vertical direction is referred to as a second flow-passage group 232, and the flow-passage group located at the lowest position in the vertical direction is referred to as a third flow-passage group 233.

Among the three flow-passage groups, the condensing portion 2a is configured of the first flow-passage group 231 and the second flow-passage group 232, and the subcooling portion 2b is configured of the third flow-passage group 233.

Hereinafter, in the second header tank 22, the section (interior space) located at the highest position in the vertical direction is referred to as the first space 221, the section located at the second highest position from above in the vertical direction is referred to as the second space 222, and the section located at the lowest position in the vertical direction is referred to as the third space 223.

The first space 221 and the second space 222 are partitioned from each other by completely closing the iris diaphragm mechanism 7. The second space 222 and the third space 223 are partitioned from each other by the first separator 81.

The first space 221 and the second space 222 communicate with the condensing portion 2a of the core 23, i.e., the first flow-passage group 231 and the second flow-passage group 232. The third space 223 communicates with the subcooling portion 2b of the core 23, i.e., the third flow-passage group 233.

A first communication passage 64 is provided between the second space 222 of the second header tank 22 and an interior space 200 of the modulator tank 20. The first communication passage 64 causes the second space 222 of the second header tank 22 to communicate with the interior space 200 of the modulator tank 20.

A second communication passage 65 is provided between the third space 223 of the second header tank 22 and the interior space 200 of the modulator tank 20. The second communication passage 65 causes the third space 223 of the second header tank 22 to communicate with the interior space 200 of the modulator tank 20.

The cylindrical modulator tank 20 is integrally provided outside the second header tank 22. The modulator tank 20 separates the refrigerant into a gas-phase refrigerant and a liquid-phase refrigerant and then stores therein the liquid-phase refrigerant. The modulator tank 20 and the second header tank 22 have a relationship in which their interior spaces communicate with each other by the first communication passage 64 and the second communication passage 65. Each of the condensing portion 2a, the subcooling portion 2b, and the modulator tank 20 is formed by pressing working, extrusion molding, or the like using an aluminum material or an aluminum alloy material. The condensing portion 2a, the subcooling portion 2b, and the modulator tank 20 are assembled together by integral brazing, for example, furnace brazing.

Although not shown, a desiccant that absorbs moisture in the refrigeration cycle and a filter that collects foreign matter in the refrigeration cycle are accommodated in the modulator tank 20.

Hereinafter, in the first header tank 21, the section (interior space) located at the upper side in the vertical direction is referred to as the fourth space 211, and the section located at the lower side in the vertical direction is referred to as the fifth space 212.

The fourth space 211 communicates with the condensing portion 2a of the core 23, i.e., the first flow-passage group 231 and the second flow-passage group 232. The fifth space 212 communicates with the subcooling portion 2b of the core 23, i.e., the third flow-passage group 233.

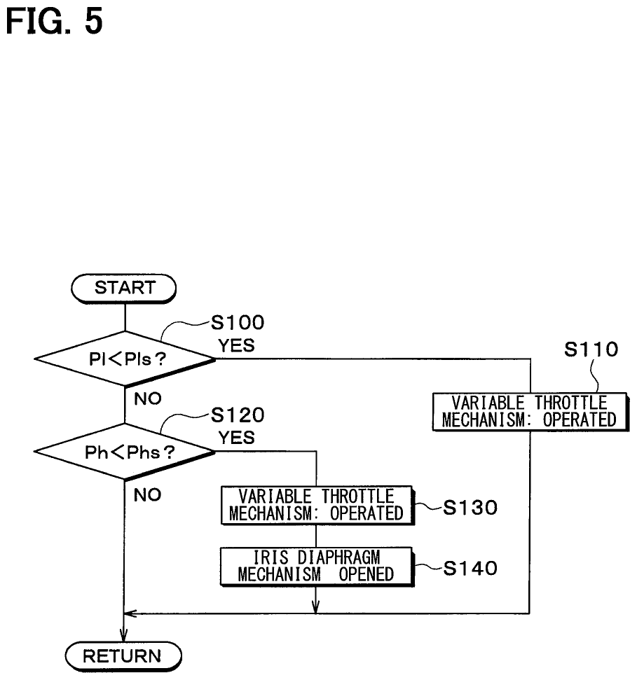

Next, the operation of the refrigeration cycle device 10 will be described. When the compressor 1 is actuated, the air-conditioning controller 6 executes the control processing shown in the flowchart of FIG. 5. The flow chart of FIG. 5 shows the control processing executed every predetermined cycle as a sub-routine for a main routine of an air-conditioning control program.

During the normal operation, the refrigeration cycle device 100 fully opens the variable throttle mechanism 5 and completely closes the iris diaphragm mechanism 7 of the radiator 2. Thus, as indicated by solid arrows in FIG. 3, the refrigerant discharged from the compressor 1 flows from the inlet side pipe joint 28 into the first space 221 of the second header tank 22 in the radiator 2. The refrigerant flowing into the first space 221 of the second header tank 22 flows through the first flow-passage group 231 of the core 23, the fourth space 211 of the first header tank 21, and the second flow-passage group 232 of the core 23 and then flows into the second space 222 of the second header tank 22.

The refrigerant having flowed into the second space 222 of the second header tank 22 flows into the interior space 200 of the modulator tank 20 via the first communication passage 64 and is subsequently separated into a gas-phase refrigerant and a liquid-phase refrigerant. Then, the liquid-phase refrigerant, which has been gas-liquid separated in the interior space 200 of the modulator tank 20, flows into the third space 223 of the second header tank 22 via the second communication passage 65.

The liquid-phase refrigerant flowing into the third space 223 of the second header tank 22 flows through the third flow-passage group 233 of the core 23 as the subcooling portion 2b and then flows into the fifth space 212 of the first header tank 21. The liquid-phase refrigerant flowing into the fifth space 212 of the first header tank 21 flows from the outlet side pipe joint 29 to the inlet side of the expansion valve 3.

Here, returning to FIG. 5, in S100, it is determined whether the low-pressure side refrigerant pressure PI of the refrigeration cycle is lower than a predetermined reference refrigerant-evaporation pressure Pls. When the low-pressure side refrigerant pressure PI is determined to be lower than the reference refrigerant evaporation pressure Pls in S100, frosting is acknowledged to occur on the evaporator 4, and then the processing proceeds to S110.

In S110, the variable throttle mechanism 5 is operated to increase the low-pressure side refrigerant pressure PI, and then the processing returns to the main routine. Thus, the refrigerant evaporation pressure in the evaporator 4 is adjusted to the reference refrigerant evaporation pressure Pls or higher, thereby preventing frost formation on the evaporator 4.

When the low-pressure side refrigerant pressure PI is determined not to be lower than the reference refrigerant evaporation pressure Pls in S100, the processing proceeds to S120. In S120, it is determined whether the high-pressure side refrigerant pressure Ph of the refrigeration cycle is lower than a predetermined reference high pressure Phs.

When the high-pressure side refrigerant pressure Ph becomes low, a difference between the high-pressure side refrigerant pressure Ph and the low-pressure side refrigerant pressure PI in the refrigeration cycle becomes small. At this time, the condensing capacity of the radiator 2 is excessively high, so that the liquid-phase refrigerant is stored in most of the space of the radiator 2, resulting in a reduced flow rate of the refrigerant flowing to the side of the evaporator 4.

When the high-pressure side refrigerant pressure Ph is determined to be lower than the reference high-pressure side pressure Phs in S120, a difference between the high-pressure side refrigerant pressure Ph and the low-pressure side refrigerant pressure PI in the refrigeration cycle is acknowledged to be small, and then the processing proceeds to S130. In S130, the variable throttle mechanism 5 is throttled, and then the processing proceeds to S140. In S140, the iris diaphragm mechanism 7 of the radiator 2 is opened, and then the processing returns to the main routine.

In this way, when the variable throttle mechanism 5 is throttled in S130, the specific volume of the suction refrigerant in the compressor 1 increases. Consequently, the flow rate of the refrigerant discharged from the compressor 1 is reduced, thus making it possible to suppress the intermittent operation of the compressor 1 under the low load condition.

When the variable throttle mechanism 5 is throttled, the temperature of the refrigerant in the evaporator 4 rises, causing a phenomenon (liquid-back) in which the refrigerant does not completely evaporate in the evaporator 4, and consequently the liquid-phase refrigerant flows out of the evaporator 4, resulting in a decrease in the degree of superheat of the refrigerant on the outlet side of the evaporator 4.

Upon the occurrence of the liquid-back, an internal pressure loss in the evaporator 4 is reduced, and thereby the refrigerant pressure at the outlet of the evaporator 4 rises, compared to the case where no liquid-back occurs, that is, the case where only the gas-phase refrigerant flows out of the evaporator 4. Then, the expansion valve 3 throttles the valve opening degree so as to reduce the refrigerant pressure at the outlet of the evaporator 4, thereby decreasing the flow rate of the refrigerant.

Subsequently, when the iris diaphragm mechanism 7 is opened in S140, as indicated by dashed arrows of FIG. 3, part of the refrigerant flowing into the first space 221 of the second header tank 22 in the radiator 2 flows into the second space 222 via the passage 72 in the iris diaphragm mechanism 7. That is, the part of the refrigerant flowing into the radiator 2 flows into the subcooling portion 2b without circulating through the first flow-passage group 231 and the second flow-passage group 232 which are the condensing portion 2a.

Thus, a heat exchange region (heat exchange area) for exchanging heat between the refrigerant and the outside air in the radiator 2 is decreased, and thereby the high-pressure side refrigerant pressure Ph in the refrigeration cycle rises. Therefore, a pressure difference (high-low pressure difference) between the high-pressure side refrigerant pressure Ph and the low-pressure side refrigerant pressure PI of the refrigeration cycle can be ensured, so that the refrigerant flow can be ensured in the refrigeration cycle.

As described above, in the vehicle air conditioner, the variable throttle mechanism 5 reduces a passage cross-sectional area of the refrigerant passage 10, for example, when the outside air temperature becomes low and the high-pressure side refrigerant pressure Ph in the refrigeration cycle also becomes low. Consequently, the specific volume of the suction refrigerant in the compressor 1 increases, so that the flow rate of the refrigerant discharged from the compressor 1 can be reduced. Thus, the intermittent operation of the compressor 1 that would otherwise occur on the low load condition, such as in winter, can be suppressed.

In the vehicle air conditioner, the iris diaphragm mechanism 7 opens the passage 72 (communication portion) inside the second header tank 22, for example, when the outside air temperature becomes low and the high-pressure side refrigerant pressure Ph in the refrigeration cycle becomes low. At this time, part of the refrigerant discharged from the compressor 1 flows into the subcooling portion 2b without passing through the condensing portion 2a, thereby decreasing a heat exchange region (heat exchange area) for exchanging heat between the refrigerant and heat medium in the radiator 2. Consequently, the high-pressure side pressure in the refrigeration cycle rises, so that the flow rate of the refrigerant circulating in the refrigeration cycle is increased. Therefore, the refrigerant flow in the refrigeration cycle can be stabilized even on the low load conditions, thereby suppressing the intermittent operation of the refrigeration cycle.

### Second Embodiment

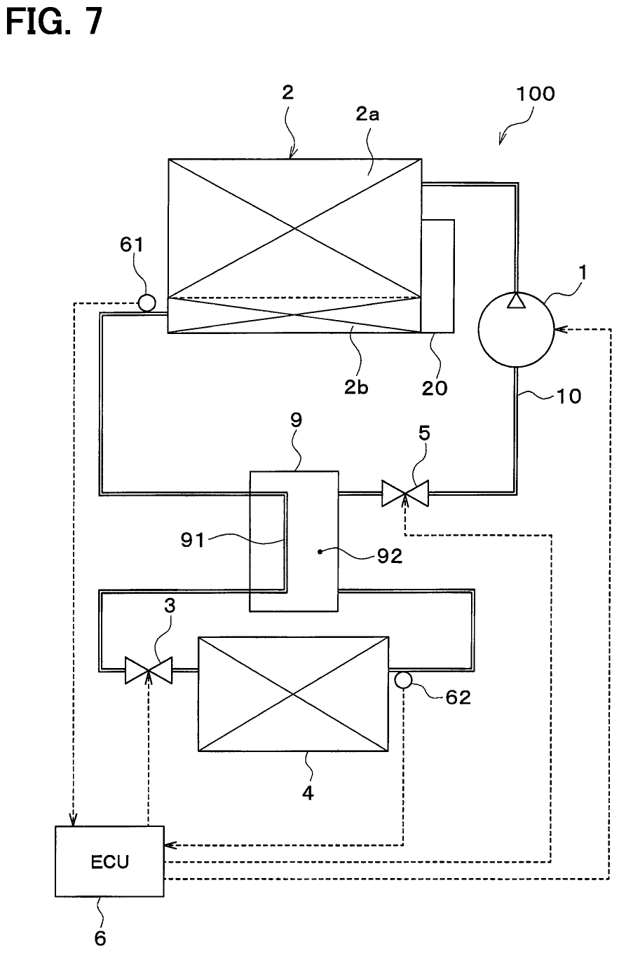

A second embodiment will be described based on FIG. 7. The second embodiment differs from the first embodiment by comparison in the structure of the refrigeration cycle.

As shown in FIG. 7, the refrigeration cycle device 100 of the present embodiment includes an internal heat exchanger 9 that indirectly exchanges heat between the high-pressure and high-temperature liquid-phase refrigerant flowing out of the radiator 2 and the low-pressure and low-temperature gas-phase refrigerant flowing out of the evaporator 4.

The internal heat exchanger 9 has a high-pressure side refrigerant flow passage 91 and a low-pressure side refrigerant flow passage 92. The high-pressure side refrigerant flow passage 91 is a flow passage through which the high-pressure side refrigerant flowing out of the radiator 2 flows. The low-pressure side refrigerant flow passage 92 is a flow passage through which the low-pressure side refrigerant flowing out of the evaporator 4 flows.

The high-pressure side refrigerant flow passage 91 is disposed on the refrigerant-flow downstream side of the radiator 2 and on the refrigerant-flow upstream side of the expansion valve 3. The low-pressure side refrigerant flow passage 92 is disposed on the refrigerant-flow downstream side of the evaporator 4 and on the refrigerant suction side of the compressor 1.

According to the present embodiment, the heat is exchanged between the high-pressure side refrigerant flowing out of the radiator 2 and the low-pressure side refrigerant heat-exchanged in and flowing out of the evaporator 4, so that the high-pressure side refrigerant can be cooled by the low-pressure side refrigerant. Thus, the enthalpy of the refrigerant on the inlet side of the evaporator 4 is reduced. Therefore, an enthalpy difference (in other words, the refrigeration capacity) between the refrigerants on the outlet and inlet sides of the evaporator 4 can be increased to thereby improve the coefficient of performance (so-called COP) of the cycle.

### Other Embodiments

The present disclosure is not limited to the above-mentioned embodiments, and various modifications and changes can be made to those embodiments without departing from the scope and spirit of the present disclosure, for example, in the following ways.

(1) The respective components of the refrigeration cycle device 100 are not limited to those disclosed in the above-mentioned embodiments.

Although in the above-mentioned embodiments, the compressor 1 adopts, for example, an electric compressor, the compressor 1 may adopt an engine-driven compressor when applied to a vehicle having an engine (internal combustion engine) and the like. Furthermore, the engine-driven compressor may adopt a variable displacement compressor that is configured to be capable of adjusting a refrigerant discharge capacity by changing its discharge displacement. The engine-driven compressor may adopt a fixed displacement compressor that adjusts a refrigerant discharge capacity by changing an operating rate of the compressor through the connection and disconnection of an electromagnetic clutch.

Although in the above-mentioned embodiments, the expansion valve 3 adopts, for example, an electric expansion valve, the expansion valve 3 may adopt a thermal expansion valve that adjusts a throttle passage area by a mechanical mechanism such that the degree of superheat of the refrigerant on the outlet side of the evaporator 4 is within a predetermined range set in advance.

Although in the above-mentioned embodiments, the evaporator 4 adopts, for example, the tank-and-tube type heat exchanger, the evaporator 4 is not limited thereto. For example, the evaporator 4 may adopt a plate stacked heat exchanger. The evaporator 4 may adopt a serpentine heat exchanger that is formed by bending a flat tube with a flat cross section in a meandering shape.

(2) Although in the above-mentioned embodiments, the opening/closing mechanism provided in the radiator 2 adopts, for example, the iris diaphragm mechanism 7, the opening/closing mechanism is not limited thereto. For example, the opening/closing mechanism may also adopt a mechanical valve that opens and closes a valve body using a mechanical mechanism.

What is claimed is:

1. A refrigeration cycle device comprising:
a compressor that compresses and discharges a refrigerant;
a radiator configured to dissipate heat from the refrigerant discharged from the compressor;
a decompression device configured to decompress the refrigerant flowing out of the radiator;
an evaporator configured to evaporate the refrigerant decompressed by the decompression device; and
a variable throttle mechanism provided in a refrigerant passage that connects the evaporator and the compressor, the variable throttle mechanism being configured to be capable of changing a passage cross-sectional area of the refrigerant passage, wherein
the radiator includes:
a plurality of tubes through which the refrigerant discharged from the compressor circulates, the plurality of tubes being stacked in a stacking direction; and
a header tank provided on an end side in a longitudinal direction of the plurality of tubes and communicating with the plurality of tubes,
a tank interior space of the header tank is partitioned into a plurality of sections arranged in the stacking direction, and
the header tank includes an opening/closing mechanism configured to open or close a communication portion through which adjacent sections of the plurality of sections communicate with each other.

2. The refrigeration cycle device according to claim 1, wherein
the variable throttle mechanism reduces the passage cross-sectional area of the refrigerant passage when a high-pressure side refrigerant pressure of a refrigerant cycle leading from a discharge port side of the compressor to an inlet side of the decompression device is lower than a predetermined reference high pressure, and
the opening/closing mechanism opens the communication portion when the high-pressure side refrigerant pressure is lower than the reference high-pressure side pressure.

3. The refrigeration cycle device according to claim 1, wherein
the opening/closing mechanism is an iris diaphragm mechanism.

4. The refrigeration cycle device according to claim 1, further comprising
an internal heat exchanger that exchanges heat between the refrigerant flowing out of the radiator and the refrigerant flowing out of the evaporator.

5. A refrigeration cycle device comprising:
a compressor that compresses and discharges a refrigerant;
a heat exchanger configured to dissipate heat from the refrigerant discharged from the compressor;
a decompression valve configured to decompress the refrigerant flowing out of the heat exchanger;
an evaporator configured to evaporate the refrigerant decompressed by the decompression valve; and
a variable throttle provided in a refrigerant passage that connects the evaporator and the compressor, the variable throttle being configured to be capable of changing a passage cross-sectional area of the refrigerant passage, wherein
the heat exchanger includes:
a plurality of first tubes through which the refrigerant discharged from the compressor flows,
a plurality of second tubes through which the refrigerant from the first tubes flows, wherein the first tubes and the second tubes are stacked in a stacking direction; and
a first header tank provided at one end side in a longitudinal direction of the plurality of first tubes and the plurality of second tubes such that the refrigerant from the first tubes flows into the second tubes through the first heater tank;
a second header tank provided at an another end side in the longitudinal direction of the plurality of first tubes and the plurality of second tubes;
a tank interior space of the second header tank is partitioned into a first space section communicating with the plurality of first tubes, and a second space section communicating with the plurality of second tubes,
the first space section and the second space section of the second header tank communicate with each other through a communication portion provided in the second header tank, and
the second header tank includes an iris diaphragm valve configured to open or close the communication portion.
